(19) United States
(12) Patent Application Publication
(10) Pub. No.: US 2013/0270413 A1
(43) Pub. Date: Oct. 17, 2013

(54) Portable Stand for an Information Display Article

(71) Applicants: John Wilber, Sutton Coldfield (GB); Steven John Douglas Wilber, Sutton Coldfield (GB)

(72) Inventors: John Wilber, Sutton Coldfield (GB); Steven John Douglas Wilber, Sutton Coldfield (GB)

(21) Appl. No.: 13/749,342

(22) Filed: Jan. 24, 2013

Related U.S. Application Data
(63) Continuation-in-part of application No. 13/327,455, filed on Dec. 15, 2011, now abandoned.

(30) Foreign Application Priority Data
Dec. 20, 2010 (GB) GB1021532.5

(51) Int. Cl. F16M 11/00

(52) U.S. Cl. CPC F16M 11/00
USPC 248/558

(57) ABSTRACT

A portable display stand including a sheet of substantially rigid but not inflexible material having a plurality of cuts to provide four sections which are moveable relative to one another such that the sheet may be converted from a first, flat configuration to a second, erected configuration in which it is able to support an information display article in an inclined position.

This is a continuation-in-part of application Ser. No. 13/327,455 filed Dec. 15, 2011. That application claimed priority to UK application GB 1021532.5 filed Dec. 20, 2010. Applications Ser. No. 13/327,455 and GB 1021532.5 are hereby incorporated by reference.

### BACKGROUND

1. Field of the Invention

This invention relates to a portable stand for an information display article and which enables an article such as a mobile phone, personal digital assistant (p.d.a.), computer tablet, electronic game or electronic book (ebook) to be supported in a hands-free manner, in an inclined position for ease of viewing.

2. Description of the Prior Art

Various designs of portable stands for portable electronic devices and other information display articles are well known and many typically are of a rigid, three dimensional form. Although they may be light in weight and may provide a stable support they are not conveniently portable.

For convenience of portability it has been proposed to provide a stand which is convertible between a compact, substantially flat form for transportation and storage and an erected form for supporting an article in one or more inclined positions for ease of hands-free viewing. One example of a known stand convertible between a storage and an erected configuration is the acrylic display stand marketed by Design Acrylics (www.designacrylics.co.uk).

However, a variety of previously proposed stands have suffered various disadvantages including one or more of not being readily converted between storage and erected configurations, of having poor stability, and not being easy and inexpensive to manufacture.

Accordingly in the prior art of US patent application 2010/0213331-A1 (Liou) there is described a display stand comprising foldable sections but which is of a kind prone to toppling in addition to requiring careful insertion of a tab section into a slit for the purpose of assembly. Thus assembly requires more care and attention than is desirable. In another prior art construction such as that of US 2010/0090085-A1 (Corrion) there is shown another display stand construction comprising foldable parts and which is of a three dimensional form comprising an integrally formed up-standing lip for holding an article in position. Thus the display stand cannot be rendered substantially flat for convenience of carrying in a wallet or the like. In particular it does not lend itself readily to being folded to a flat configuration for convenient carrying in a wallet or the like.

### SUMMARY OF THE INVENTION

The present invention seeks to provide an improved portable stand in which at least some of the aforedescribed disadvantages are mitigated or overcome.

In accordance with one aspect of the present invention there is provided a portable display stand comprising a sheet of material which in a first configuration lies flat and which comprises a plurality of cuts lying within the outer periphery of the sheet thereby to provide at least four sections which are moveable relative to one another to convert the sheet from the first, flat configuration to a second, erected configuration in which it is able to support an information display article in an inclined position, said plurality of cuts being arranged to define the outlines of at least a base section for resting, in use, on a support surface, a foot stop against which, in use, a lower edge of an information display article may be restrained from sliding downwards from an inclined position, a back support, and a tab, the foot stop, back support and tab each being inclinable relative to the base section by movement in the same rotational direction about their respective hinge positions, the back support and tab being shaped to define retention formations which are inter-engagable to secure each of the back support and the tab in a position inclined relative to the base section, and said portable display stand further comprising any one or more of the following features:—
the back support comprising a retention formation such as a lug or aperture which is part of the outer periphery of the sheet when said sheet is in the first, flat configuration and which in use inter-engages with the tab to secure the stand in the second configuration;
the tab having a retention formation comprising an edge formation, such as at least one notch in at least one edge of the tab, or at least one aperture between edges of the tab for engaging with a retention formation in the back support, and optionally comprising a plurality of edge formations or apertures whereby the back support may be selectively secured relative to the tab in any one of two or more inclined positions thereby to provide a selection of viewing angles for a supported article;
apart from any voids which define a retention formation of the tab, the sheet being devoid of any voids such as apertures within the outer periphery of the sheet, and, optionally, the plurality of cuts being formed by die cutting or a similar technique whereby the two confronting edges formed by a cut are in contact or substantially adjacent one another;
one or more or all of the cuts which provide the four sections of the display stand may extend through the thickness of the sheet material in a direction perpendicular to the outer surfaces of the sheet or one or more cuts may be inclined relative to said surfaces whereby one or more of the foot stop, tab and back support is rotatable only in one direction relative to the base section;
for at least one and preferably each of the foot stop, back support and tab the sheet material comprising a hinge position comprising a cut which extends along a part of the length of the hinge position, said cut optionally being formed by die cutting;
the respective hinge positions for each of the foot stop, back support and tab each having mutually parallel hinge axes;
the respective hinge positions for each of the foot stop, back support and tab each having substantially mutually parallel hinge axes and the hinge axis for the tab lying between the hinge axis for the back support and the hinge axis for the foot stop;
at least one hinge position having a hinge axis which is slightly curved along the length thereof, at least when the display stand is in the first, flat configuration, whereby the consequential deformation of the sheet when moved to the second, erected configuration results in the sheet inherently tending to rotate about said hinge axis in a direction towards the first, flat configuration;
the hinge positions being positioned to lie wholly within and spaced inwards from the outer periphery of the sheet;
one or each of the tab and back support having a distal edge region which defines a part of the boundary of the sheet when in the first configuration;
the base section comprising at least one stabiliser region which extends beyond the hinge position of the back support, as considered in a direction away from the foot stop;
each of the foot stop, back support and tab being defined by cuts which lie relative to their respective hinge positions such that they are each movable in the same direction when converting from the first, flat configuration to the second, erected configuration;
an edge region of the outer periphery which is formed with the notch is profiled to provide two support zones which are spaced apart at opposite sides and remote from the notch, said support zones lying further from the back support hinge position than the part of the edge region adjacent the notch. At least a part of said edge region may be of a concave shape with the notch preferably lying centrally of the concave profile.

Other features which similarly may be incorporated in the display stand are described below.

### DESCRIPTION OF THE FIGURES

FIG. 1 is a plan view of a portable display stand in accordance with a first embodiment of the present invention;

FIG. 2 is perspective view of the display stand of FIG. 1;

FIG. 3 shows the stand of FIGS. 1 and 2 in a first stage of conversion to a second configuration;

FIG. 4 shows the stand of FIGS. 1 and 2 in one of a plurality of alternative second configurations;

FIG. 5 shows the stand of FIGS. 1 and 2 in a second configuration different from that of FIG. 4;

FIG. 6 shows the portable stand in use to support an article;

FIG. 7 shows in plan a portable stand in accordance with a second embodiment of the present invention;

FIG. 8 shows in plan a portable stand in accordance with a third embodiment of the present invention;

FIG. 9 is a perspective view, part cut away, of a portable display stand in accordance with another embodiment of the present invention;

FIG. 10 shows in plan view part of the stand of FIG. 9;

FIG. 11 shows enlarged the detail A of FIG. 9 as viewed in the direction of the hinge axis 73, and

FIG. 12 is a perspective view showing the portable display stand of FIGS. 9 to 11 in use to support a computer tablet.

### DESCRIPTION OF THE PREFERRED EMBODIMENTS

The portable stand may be of a substantially rectangular shape and conveniently may be of a credit card size, i.e. in the order of 55×85 mm (approximately 2.2 by 3.5 inches). That size is suitable for supporting, for example, a mobile phone or a larger item such as a notebook or ebook. However it will be appreciated that a larger version may be provided, for example for supporting a larger item or for providing a larger sized base section so as to afford adequate stability and resistance to toppling when used on an uneven or inclined support surface.

The substantially rectangular shape may be square or may comprise adjacent edges of different sizes. In the latter case preferably the hinge positions provide hinge axes which are substantially parallel with the shorter edges of the rectangular shape.

The sheet material of the portable display stand should be selected to be sufficiently rigid as compared, for example, with conventional writing paper (e.g. of 80 gsm weight) such that each of the sections will remain substantially flat when the stand is in the second, erected configuration. However at least parts of the sheet of material should be sufficiently flexible whereby, without the need necessarily to attach separate hinge components to the sheet, the material of the stand can be repeatedly flexed at the hinge positions thereby to allow the at least four sections to be moved relative to one another by pivotal action.

The sheet material should be selected such that at least the base and back support are able adequately to withstand deformation when in use in the erected configuration.

Suitable materials for the portable stand include plastics materials such as polyethylene, polypropylene, nylon, polyester or other thermoplastic elastomer. Another suitable material, particularly for a portable display stand for supporting relatively small devices, is a tear resistant type of paper such as that available from Lloyd Paton under the brand name “Xerox Premium Never Tear 195U White Polyester” and having a thickness of 195 micron (approximately 0.0075 inches).

The material may be in sheet form, having two opposite sides which are each flat. However, for a stand which is dimensioned to support a relatively large display device such as a electron book in contrast to a mobile phone, it may comprise a layer of material at least one side which is non-planar and is provided with reinforcing formations, such as reinforcing webs, that impart stiffness but do not increase weight unduly as compared with a display stand formed from a sheet having two flat sides and a sufficient thickness to provide a similar stiffness.

In addition or as an alternative to providing a layer of material at least one side of which is non-planar, the present invention teaches that advantageously a portable display stand may be formed from a sheet of laminate material.

Thus, in accordance with another aspect of the present invention there is provided a portable display stand comprising a sheet of material which in a first configuration lies flat and which comprises a plurality of cuts thereby to provide sections which are moveable relative to one another about at least one hinge position to convert the sheet from a first, flat configuration to a second, erected configuration in which it is able to support an information display article in an inclined position, said portable display stand having sections defined by a sheet of laminate material wherein one of the layers of the laminate is discontinuous at regions where the or each other layer is continuous thereby to form said at least one hinge position about which one section of the sheet may be hinged relative to one or more other sections for converting between said first and a second configurations.

In accordance with yet another aspect of the present invention there is provided a method of constructing a portable display stand comprising providing a sheet of laminate material, forming aligned cuts in each of the layers of the laminate thereby to define, at least in part, two or more sections of the portable display stand, and cutting through one of the layers thereby to provide at least one hinge position about which one section of the sheet material is moveable relative to the other between a first configuration in which the sheet is substantially flat and a second configuration in which one section has been inclined relative to another for supporting an information display article in an inclined position.

A particularly suitable type of laminate material is one comprising two outer layers having sandwiched therebetween and bonded thereto an inner layer of polymeric material the flexibility of which is greater than that of either of the outer layers.

Accordingly the present invention envisages that a sheet of substantially rigid but not inflexible material for forming the display stand may comprise a layer of relatively flexible material substantial regions of which are rendered relatively inflexible by virtue of the sandwich construction having outer and relatively inelastic layers such as thin layers of metal bonded or otherwise secured to the core layer.

A particularly suitable construction of the laminate sheet is one comprising two outer layers of a metallic material, such as aluminium, having bonded therebetween a layer of a plastics material such as polypropylene. Preferably the outer layers are relatively thin compared with the inner layer, and in particular the inner layer may have a thickness which is at least twice the combined thickness of the outer layers. Thus in one example the inner layer of polymeric material may be a layer of polymeric material having a thickness of 0.8 mm (approximately 0.03 inches) and two outer layers of aluminium sheet each having a thickness of 0.2 mm (approximately 0.008 inches).

To form hinge positions in a laminate material one or optionally both of the outer layers may be cut such that the polymeric layer is then relatively free to flex and provide a hinge position.

Optionally the material of one or each of the outer layers of a laminate may be cut to provide a slightly curved cut line such that the resulting hinge position provides a resistance to movement about the hinge axis which is greater than that provided by a straight line hinge axis of the same length. Similarly, in respect of non laminated material a hinge axis may be slightly curved such that the resulting hinge position provides a resistance to movement about the hinge axis which is greater than that provided by a straight line hinge axis of the same length.

In accordance with another aspect of the present invention there is provided a method for manufacture of a portable stand of the type comprising a sheet of material which comprises at least four sections which are movable relative to one another to convert the sheet from a first, flat configuration to a second, erected configuration in which it is able to support an information display article in an inclined position, said sections being defined by a plurality of cuts each formed by the process of die cutting whereby confronting edges of a cut are in contact or substantially adjacent to one another, said plurality of cuts being arranged to define a base section for resting in use on a support surface, a foot stop for restricting an information display article from sliding downwards from an inclined position, a back support, and a tab, the foot stop, back support and tab each being inclinable relative to the base section about respective hinge positions and the back support and tab being shaped by the die cutting operation to define formations which are inter-engagable to secure each of the back support and tab in a position inclined relative to the base section.

The display stand material lying within the outer periphery of the sheet may be cut solely by die cutting. Preferably with the exception of the or each retention formation, the sheet is substantially devoid of any apertures.

In the case of a display stand formed from laminated sheet material the sheet may be provided with at least four sections and at least three hinge positions by means of a router or the like to cut through the full thickness of parts of the sheet material to form the sections and to cut through substantially only one or each of the outer layers to form the hinge positions.

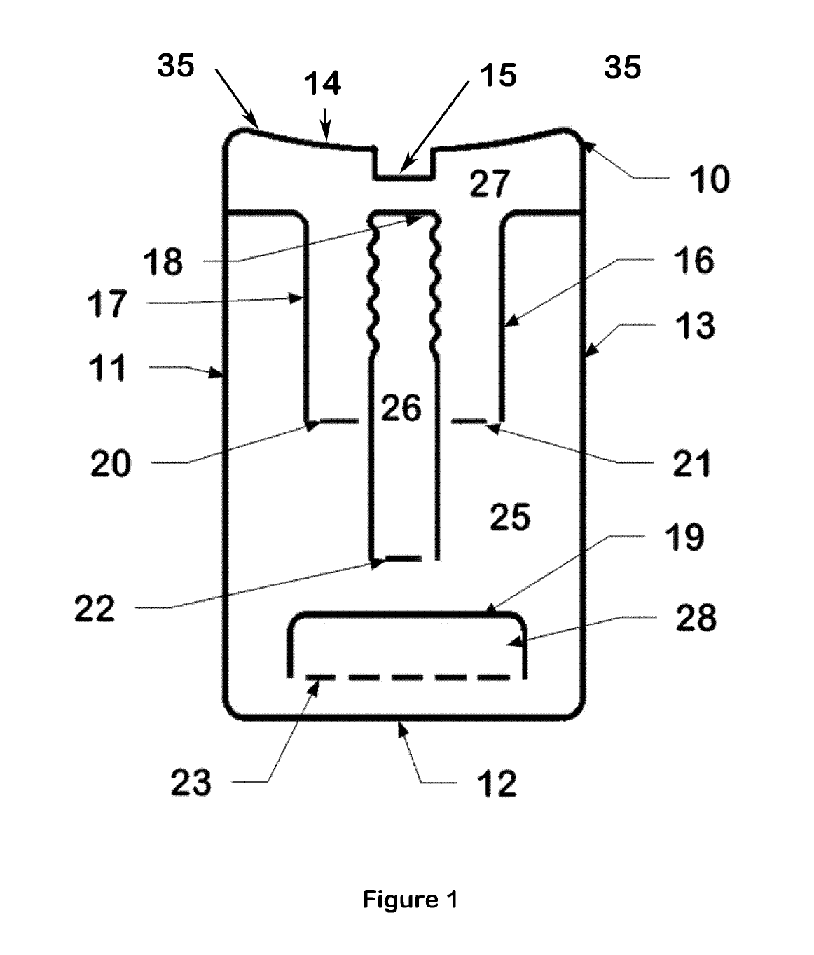

A portable display stand 10 (see FIGS. 1 to 6) comprises a rectangular sheet of polypropylene of credit card size and shape. Three edges, 11, 12, 13 are straight but optionally, as in this embodiment of the invention, one, 14, of the shorter edges is concave and formed centrally with a notch 15.

The sheet is die cut to create four cuts 16-19 and four series of short length cuts or series of cuts which provide hinge positions 20-23 as described in more detail below.

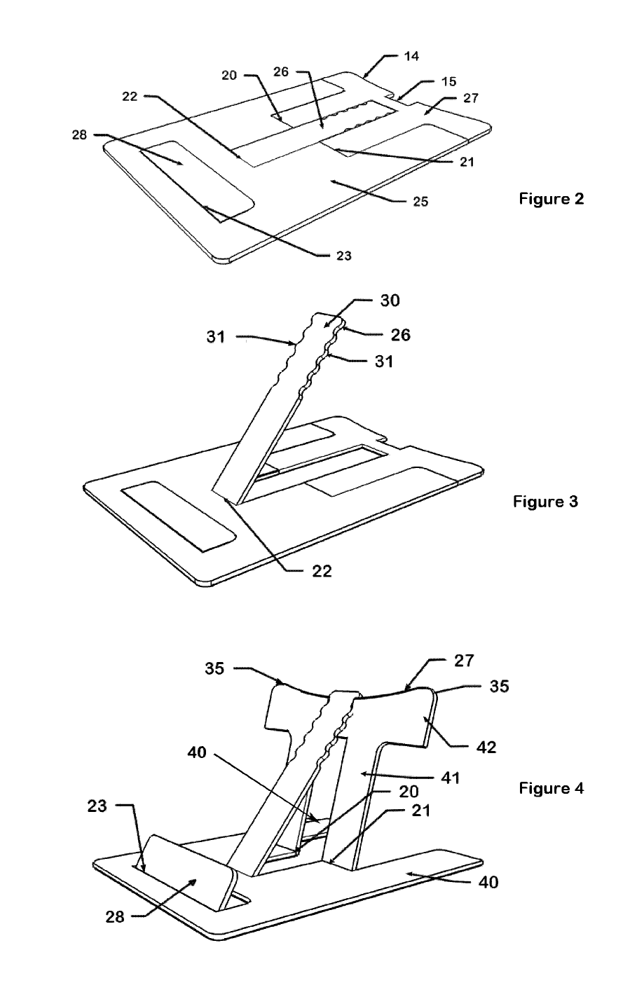

The cuts 16-19 define four sections, namely a base section 25, a tab section 26, a back support 27 which comprises the concave edge 14 and notch 15, and a foot stop 28. The base section defines a part of the edge 14 which is at the outer boundary of the stand 10 when in the configuration shown in FIGS. 1 and 2.

The tab 26 (see FIG. 3) can be pivoted upwards from the base section about the hinge position 22.

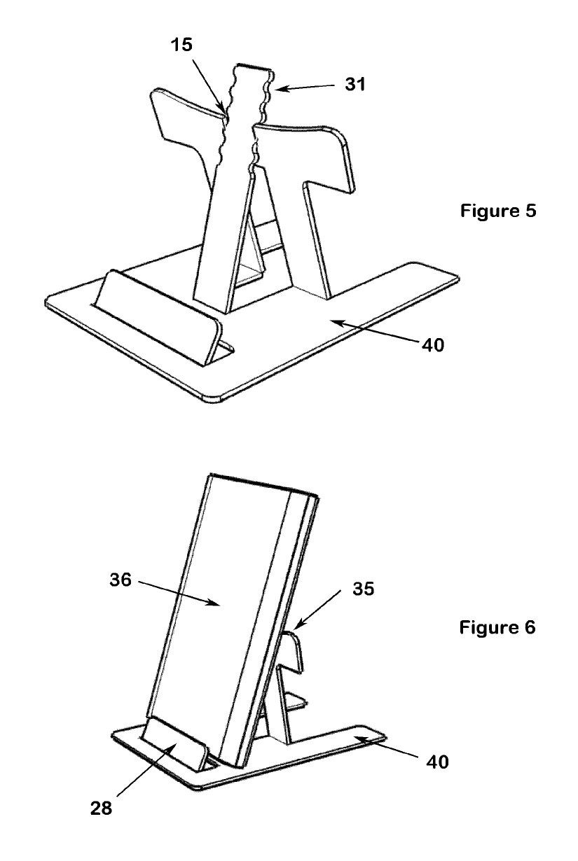

The back support 27 (see FIG. 4) similarly can be pivoted upwards, in the same direction as the tab, about the hinge positions 20, 21.

Likewise the foot stop 28 can be pivoted upwards, in the same direction as the tab, to an inclined position, as also shown in FIG. 4, about the hinge position 23.

The distal end 30 of the tab 26 is provided with a series of five pairs of tab notches 31. The two tab notches of each pair are provided on the two parallel edges of the tab that extend lengthwise away from the hinge position 22. The distance across the tab between the bases of the tab notches of any pair corresponds with the width of the notch 15 in the back support 27. Accordingly, as made clear by FIGS. 4 and 5, the back support can be secured in an inclined position relative to the base section 25 in any one of five positions, thus providing the option of various viewing angles or the alternatives of landscape or portrait viewing of the device being used. In each of those positions outer edge regions 35 (see FIG. 4) of the concave edge 14, namely the edge regions spaced remote from the notch 15, provide spaced apart support for a supported information display article such as an electronic device 36 (see FIG. 6). In the position as shown in FIG. 6 the device 36 is restrained from sliding downwards from the inclined position by virtue of the foot stop 28.

As evident from FIGS. 4-6, the base section comprises two regions 40 that extend beyond the back support hinge axes 20,21 in a direction away from the foot stop 28. In consequence of the rigidity of the sheet material from which the stand is formed these regions 40 serve as base stabiliser regions to resist toppling in the event of the stand being used to support an article for which the centre of gravity acts further from the foot stop than the back support hinge positions, 20, 21. Similarly when force is applied to a screen display with a finger or probe.

In this embodiment of the present invention the stabiliser regions 40 lie adjacent the respective longer edges 11, 13 of the stand. That is, they lie outwards of limb portions 41 which extend from the back support hinge positions 20,21 to the head portion 42 of the back support (see FIG. 4). In this position, in which the two stabiliser regions 40 are widely spaced, they are well positioned to resist any tendency for sideways toppling in addition to rearwards toppling. However it is not essential that stabiliser regions are provided at outward positions adjacent the aforementioned longer edges.

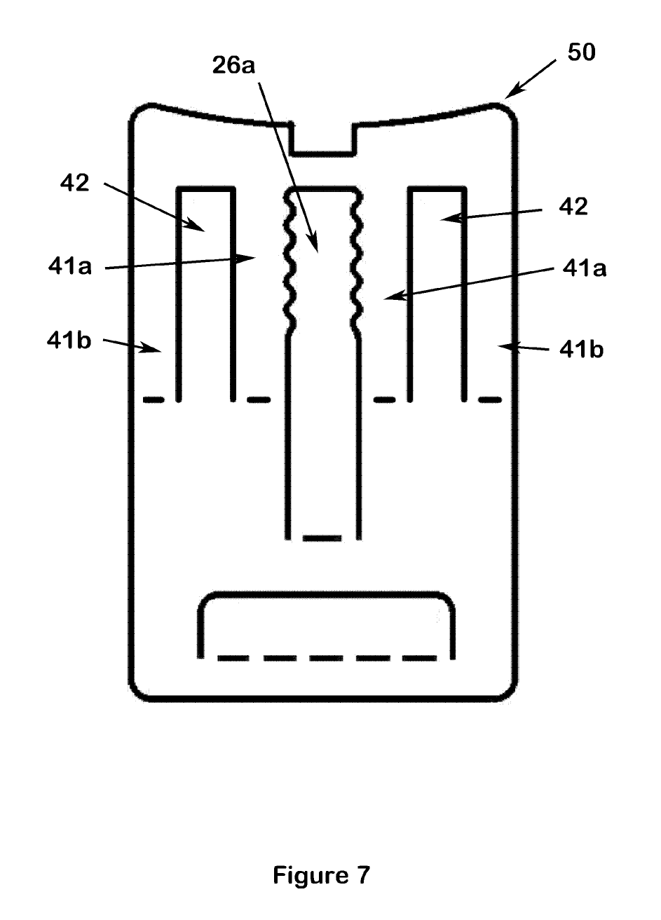

In a second embodiment of the present invention, illustrated with reference to FIG. 7, a portable stand 50 is constructed substantially as described above except that limb portions 41 of the back support 27 are each divided to provide two limb sections 41a,41b. The base section comprises a pair of stabiliser regions 42 which each lie interposed between a pair of neighbouring limb portions 41a, 41b.

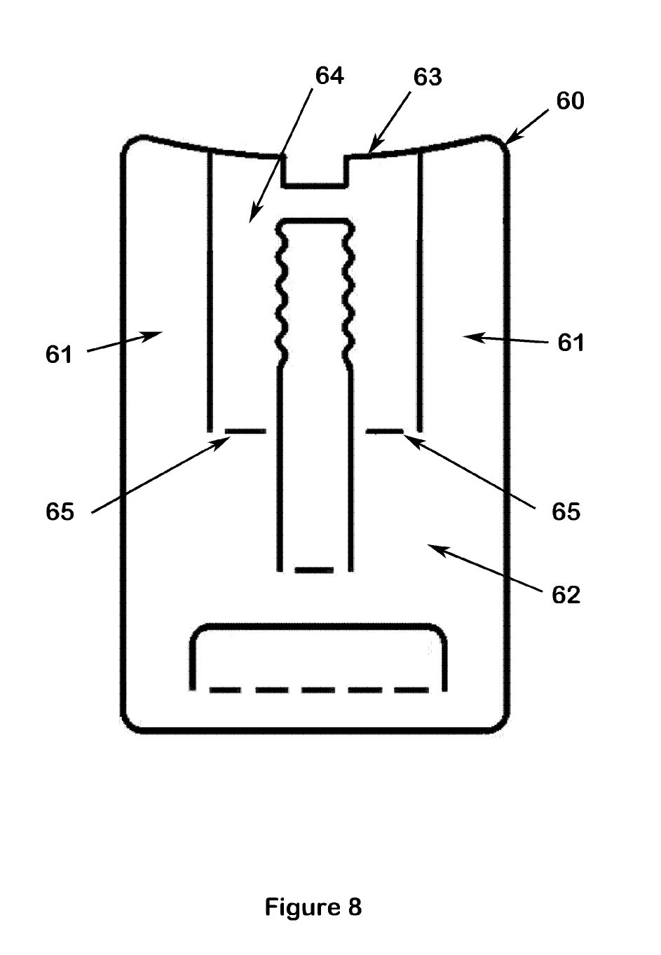

In a third embodiment of the present invention (see FIG. 8) a portable stand 60 is constructed substantially as described in respect of the first embodiment of the invention except that the base 62 comprises stabiliser regions 61 which are of a greater length than those of the first embodiment. In consequence the edge portion 63 of the back support 64 is narrower. In this construction the greater length of the stabiliser regions, as extending beyond the back support hinge regions 65, provides the stand with an enhanced degree of resistance to toppling in a rearwards direction.

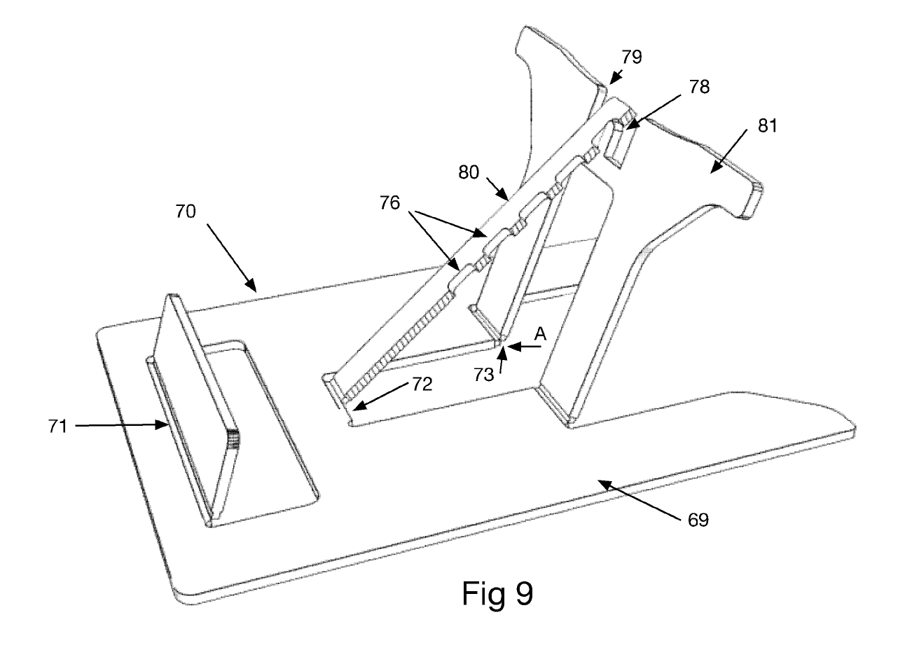

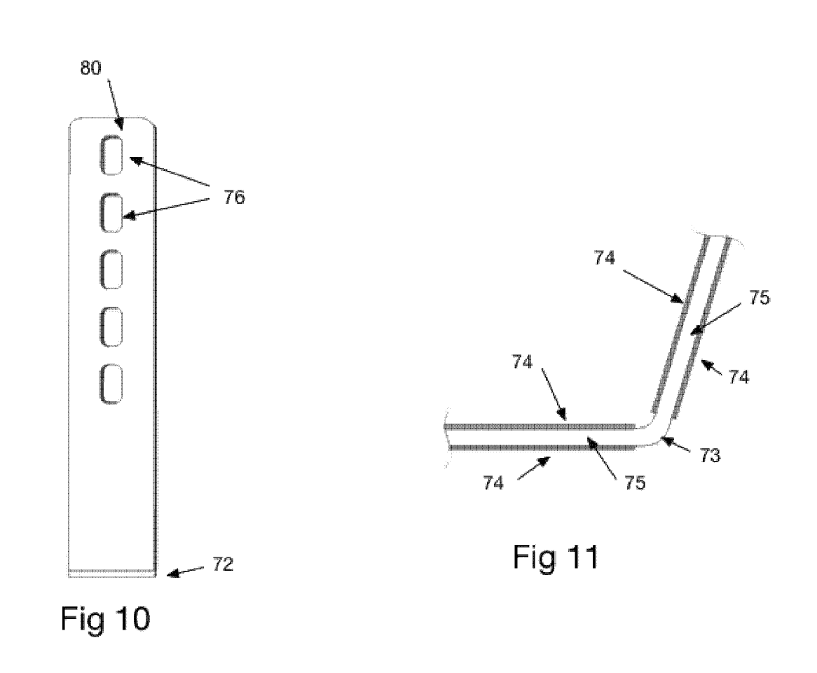

In a fourth embodiment of the present invention (see FIGS. 9 to 12) a portable display stand 70 is constructed substantially as described in respect of the first embodiment except that the sheet material is of a laminate type (see inset detail of FIG. 9 as shown in FIG. 11) comprising two outer aluminium layers 74 each of a thickness 0.2 mm (approximately 0.08 inches) which are bonded to and have sandwiched therebetween a layer 75 of polypropylene having a thickness of 0.8 mm (approximately 0.03 inches).

To form, the hinge positions 71, 72, 73 for the foot stop, tab and back support in the base section 69 the metallic outer layers 74 are each cut thereby to leave the inner polypropylene layer 75 free to flex and define the respective hinge positions. A further feature of this embodiment of the invention is that instead of the tab section 80 being formed with a series of notches it is provided with a series of retention slots 76 each of which may be selected for engagement with a retention lug formation 78 provided centrally within a notch 79 in the outer edge of the back support 81. Thus by selecting which slot 76 is engaged with the lug formation 78 the angle of inclination of an article supported by the display stand may be selectively adjusted.

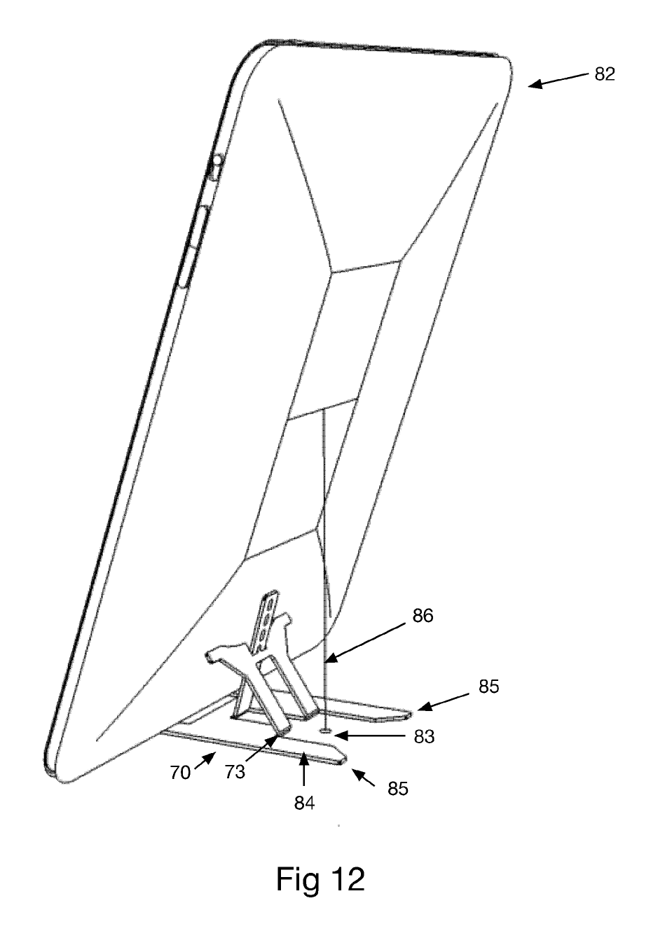

From FIG. 12 it will be seen that the credit card sized stand 70 formed from laminate material is effective to support a relatively much larger computer tablet 82 in an inclined position in which the centre of gravity of the tablet, acting in the direction of the line 86, falls at a position 83 lies within the length of the stabiliser regions 84 of the base section, i.e. between the back support hinge axis 73 and the distal ends 85 of the stabiliser regions

From the foregoing it will be appreciated that the present invention provides a portable display stand which may be readily converted between storage and erected configurations, has improved stability as compared with the earlier referred to prior art device and, particularly for those formed from non-laminated material, may be manufactured economically.

Surprisingly it has been found that a display stand formed from laminated material will have sufficient strength to support items such as computer tablets of a weight and size significantly greater than a mobile phone even if the stand is of a relatively small credit card size as described above. Thus a display stand in accordance with the present invention, formed of laminated material and having the size of a credit card has been found to be well able to support a tablet or the like of a size 19 by 24 mm (approximately 7.5 by 9.5 inched).

Furthermore the display stand as described above advantageously allows the viewing angle to be adjusted easily as well as allowing an information display article to be supported in either of, and readily moved between, a landscape and a portrait viewing mode.

Several descriptions and illustrations have been provided to aid in understanding the present invention. One with skill in the art will realize that numerous changes and variations may be made without departing from the spirit of the invention. Each of these changes and variations is within the scope of the present invention.

1. A portable display stand comprising a sheet of substantially rigid but not inflexible material which in a first configuration lies flat and which comprises a plurality of cuts lying within a boundary defined by the outer periphery of the sheet thereby to provide at least four sections which are moveable relative to one another to convert the sheet from the first, flat configuration to a second, erected configuration in which it is able to support an information display article in an inclined position, said plurality of cuts being arranged to define the outlines of at least a base section for resting, in use, on a support surface, a foot stop against which, in use, a lower edge of an information display article may be restrained from sliding downwards from an inclined position, a back support and a tab, the foot stop, back support and tab each being inclinable relative to the base section by movement in the same rotational direction about their respective hinge positions, the back support and tab being shaped to define retention formations which are inter-engagable to secure each of the back support and the tab in a position inclined relative to the base section, and said portable display stand further comprising two stabiliser regions which each extend beyond the hinge position of the back support as considered in a direction away from the foot stop, said two stabiliser regions being spaced apart as considered in a direction perpendicular to said direction in which they extend beyond the hinge position of the back section.

2. A portable display stand according to claim 1 wherein the back support comprises a retention formation which defines part of the outer periphery of the sheet when in the first, flat configuration and which, in use, inter-engages with the tab to secure the stand in the second configuration.

3. A portable display stand according to claim 2 wherein the back support comprises a retention formation in the form of a notch and the tab comprises a plurality of edge formations each for engaging with the notch in the back support whereby the back support may be selectively secured relative to the tab in any one of two or more inclined positions.

4. A portable display stand according to claim 2 wherein the back support comprises a retention formation in the form of a lug and the tab comprises at least two apertures each for engaging with the lug in the back support whereby the back support may be selectively secured relative to the tab in any one of two or more inclined positions.

5. A portable display stand according to claim 1 wherein with the exception of the or each retention formation the sheet is substantially devoid of any voids inwards of the outer periphery of the sheet when in said first configuration.

6. A portable display stand according to claim 1 and comprising a sheet of laminated material of a credit card size, being approximately 2.2 by 3.3 inches (55 by 85 mm).

7. A portable display stand according to claim 1 wherein, for at least one of the foot stop, back support and tab, the sheet material comprises a hinge position which comprises a cut which extends along a part of the length of the hinge position.

8. A portable display stand according to claim 7 wherein the sheet is a sheet of laminated material which comprises two outer layers having sandwiched therebetween a layer of polymeric material which is more flexible than either of said outer layers and wherein a cut is provided substantially only in at least one of the two outer layers thereby to provide a said hinge position.

9. A portable display stand according to claim 1 wherein the respective hinge positions for each of the foot stop, back support and tab each have mutually parallel hinge axes and the hinge axis for the tab lies between the hinge axis for the back support and the hinge axis for the foot stop.

10. A portable display stand according to claim 1 wherein the entire length of each of said hinge positions of each of the foot stop, back support and tab is spaced inwards from said outer periphery of the sheet.

11. A portable display stand according to claim 1 wherein at least one of the back support and tab has an edge region furthest from the respective hinge axis thereof and said edge region defines a part of the outer periphery of the sheet when the sheet is in said first, flat configuration.

12. A portable display stand according to claim 1 wherein said two stabiliser regions each lie adjacent a respective one of a pair of opposite edges of the sheet thereby to define a part of the boundary of the sheet when in the first, flat configuration.

13. A portable display stand according to claim 1 wherein an edge region of the outer periphery is formed with a said retention formation and said edge region is profiled to provide two support zones spaced apart, at opposite sides of and remote from said retention formation.

14. A portable display stand according to claim 13 wherein said spaced apart support zones lie further from the back support hinge position than the parts of the edge region adjacent said retention formation.

15. A portable display stand according to claim 1 wherein the sheet is a laminate comprising two outer layers of metallic material having sandwiched therebetween and bonded thereto a layer of polymeric material and at least one of the outer layers being cut to define a hinge position.

16. A portable display stand comprising a sheet of material which in a first configuration lies flat and which comprises a plurality of cuts lying within a boundary defined by the outer periphery of the sheet thereby to provide at least four sections which are moveable relative to one another to convert the sheet from the first, flat configuration to a second, erected configuration in which it is able to support an information display article in an inclined position, said plurality of cuts being arranged to define the outlines of at least a base section for resting, in use, on a support surface, a foot stop against which, in use, a lower edge of an information display article may be restrained from sliding downwards from an inclined position, a back support and a tab, the foot stop, back support and tab each being inclinable relative to the base section by movement in the same rotational direction about their respective hinge positions when converting from the first towards the second configuration, the back support and tab being shaped to define retention formations which are inter-engagable to secure each of the back support and the tab in a position inclined relative to the base section, at least one of the back support and tab comprising an edge region furthest from the respective hinge position thereof and said edge region defining a part of said outer periphery of the sheet when the sheet is in the first, flat configuration, said portable stand further comprising two stabiliser regions which each extend beyond the hinge position of the back section as considered in a direction away from the hinge position of the foot stop, said two stabiliser regions being spaced apart as considered in a direction perpendicular to said direction in which they extend beyond the hinge position of the back support, said base section comprising a pair of distal edge regions which are spaced apart as considered in a direction perpendicular to said hinge positions, said hinge positions each comprising hinge axes about which each of the foot stop, back support and tab may be rotated and said hinge axes each lying wholly within and spaced inwards from said outer periphery of the sheet.

17. A portable display stand comprising a sheet of material which in a first configuration lies flat and which comprises a plurality of cuts lying within a boundary defined by the outer periphery of the sheet thereby to provide at least four sections which are moveable relative to one another to convert the sheet from the first, flat configuration to a second, erected configuration in which it is able to support an information display article in an inclined position, said sheet being a sheet of laminated material comprising two outer layers having sandwiched therebetween a layer of polymeric material which is more flexible than either of said outer layers, said plurality of cuts being arranged to define the outlines of at least a base section for resting, in use, on a support surface, a foot stop against which, in use, a lower edge of an information display article may be restrained from sliding downwards from an inclined position, a back support and a tab, the foot stop, back support and tab each being inclinable relative to the base section by movement in the same rotational direction about their respective hinge positions when converting from the first towards the second configuration, the back support and tab being shaped to define retention formations which are inter-engagable to secure each of the back support and the tab in a position inclined relative to the base section, at least one of the back support and tab comprising an edge region furthest from the respective hinge position thereof and said edge region defining a part of said outer periphery of the sheet when the sheet is in the first, flat configuration, said portable display stand further comprising two stabiliser regions which each extend beyond the hinge position of the back support as considered in a direction away from the hinge position of the foot stop, said two stabiliser regions being spaced apart as considered in a direction perpendicular to said direction in which they extend beyond the hinge position of the back section, said base section comprising a pair of distal edge regions which are spaced apart as considered in a direction perpendicular to said hinge positions, said hinge positions each comprising hinge axes about which each of the foot stop, back support and tab may be rotated and said hinge axes each being defined by at least one cut which extends through substantially only at least one of the outer layers.

18. A portable display stand according to claim 17 wherein said two stabiliser regions each lie adjacent a respective one of a pair of opposite edges of the sheet.

19. A portable display stand according to claim 17 wherein the hinge axes each lie wholly within and spaced inwards from said outer periphery of the sheet.

20. A portable display stand according to claim 17 wherein the sheet of laminated material is of a credit card size, being approximately 2.2 by 3.3 inches (55 by 85 mm).
